(19) United States
(12) Patent Application Publication
(10) Pub. No.: US 2001/0007455 A1
(43) Pub. Date: Jul. 12, 2001

(54) Method of menu-driven control of an external connected device in an audio/video apparatus

(76) Inventors: Jea-Yong Yoo, Seoul (KR); Byung-Jin Kim, Kyunggi-do (KR); Kang-Soo Seo, Kyunggi-do (KR); Hyung-Sun Kim, Seoul (KR); Nam-Seok Jo, Kyunggi-do (KR); Sang-Il Seo, Seoul (KR)

Correspondence Address: BIRCH STEWART KOLASCH & BIRCH, PO BOX 747, FALLS CHURCH, VA, 22040-0747, US

(21) Appl. No.: 09/748,250

(22) Filed: Dec. 27, 2000

(30) Foreign Application Priority Data
Dec. 27, 1999 (KR) 99-63021

(51) Int. Cl. G09G 5/08

(52) U.S. Cl. 345/856

(57) ABSTRACT

The present invention relates to a method of menu-based control of external devices connected to a digital audio/video apparatus. According to this invention, in response to user's request of a menu for selection of the external devices that have been connected to the digital audio/video apparatus, a menu image is displayed on the digital audio/video apparatus, each menu item corresponding to each of the connected external device. When one of the external devices is selected from the menu, a menu image including menu items for executing operations of the selected external device is requested and displayed on the digital audio/video apparatus. The operations of the selected external device can be selected and executed from the menu. This invention allows a user to conveniently, centrally examine and execute various operations or functions of external devices such as a DVD player that are connected to a central digital audio/video apparatus without the direct access to the external devices.

### BACKGROUND OF THE INVENTION

1. Field of the Invention

The present invention relates to a method of menu-based control of external devices that are connected to a digital audio/video apparatus, and more particularly, to a method of displaying various menu items associated with functions or operations of an external device like a digital versatile disc (hereinafter DVD) player on the displaying unit of a digital audio/video apparatus, and of remotely executing a desired function or operation of the external device by selection of the corresponding menu item on the displaying unit.

2. Description of the Related Art

An analog audio/video apparatus of the conventional arts does not have communication means with which operations or functions on external audio/video devices that are connected to the audio/video apparatus can be activated or controlled remotely on the audio/video apparatus. Therefore, in order to activate or execute the functions or operations of such an audio/video apparatus, a user should enter a control key that corresponds to the desired function or operation through a control unit dedicated to the external device.

Recently, it has been considered that disc players such as CD player and MD player will be equipped with a digital interface like the IEEE 1394 through which the functions or operations of each external digital device connected to a disc player are controlled by communication of data and commands between them.

On the other hand, the standardization on the detailed specifications of the DVD has been in progress. The DVD player is expected to be widely used in connection with a digital television through the IEEE 1394 interface in the near future. In this case, it is possible and desirable that retrieval of contents of the DVD and the execution of operations or functions of the DVD player are requested by selecting menu items on the displaying unit of the digital television that is connected to the DVD player.

To accomplish this, the method of displaying the menu items associated with operations or functions of the DVD player on the displaying unit of the digital television, and remotely executing the operations or functions in response to the selection of the corresponding menu items should be specified in detail and standardized. Because the digital television still does not support such a method, the application of the method to a digital television is preferable to enhance the convenience of users.

### SUMMARY OF THE INVENTION

It is therefore a primary object of the present invention to provide a method of displaying various menu items on a displaying unit of a digital audio/video apparatus like digital television, each menu item associated with each of the functions or operations provided by an external device that is connected to the digital audio/video apparatus through the IEEE 1394 interface, and of remotely executing a desired function or operation of the external device in response to selection of the corresponding menu item on the displaying unit.

The method of menu-based remote control of external devices that are connected to an audio/video apparatus according to the present invention, comprises the steps of: (1) displaying a menu image including menu items corresponding to respective ones of the external devices such that one of the external devices is selected from the menu; (2) requesting to the selected external device a menu image including detailed menu items associated with operations or functions provided by the selected external device; (3) receiving the menu data for detailed menu from the selected external device and displaying the menu data, the menu data being provided from the selected device without data conversion for constructing . menu screen.

### BRIEF DESCRIPTION OF THE DRAWINGS

The accompanying drawings, which are included to provide a further understanding of the invention, illustrate the preferred embodiments of this invention, and together with the description, serve to explain the principles of the present invention.

In the drawings:

FIG. 1 is a partial block diagram of a digital television embodying the present invention;

FIGS. 2A-2C and 2D show the three menu images and audio/video signal reproduced from a DVD player on a digital television embodying the present invention, respectively; and

FIG. 3 is a flowchart of the method of menu-based control of a DVD player according to an embodiment of the present invention.

### DESCRIPTION OF THE PREFERRED EMBODIMENT

Hereinafter, preferred embodiments of the present invention will be described in detail referring to the accompanying drawings.

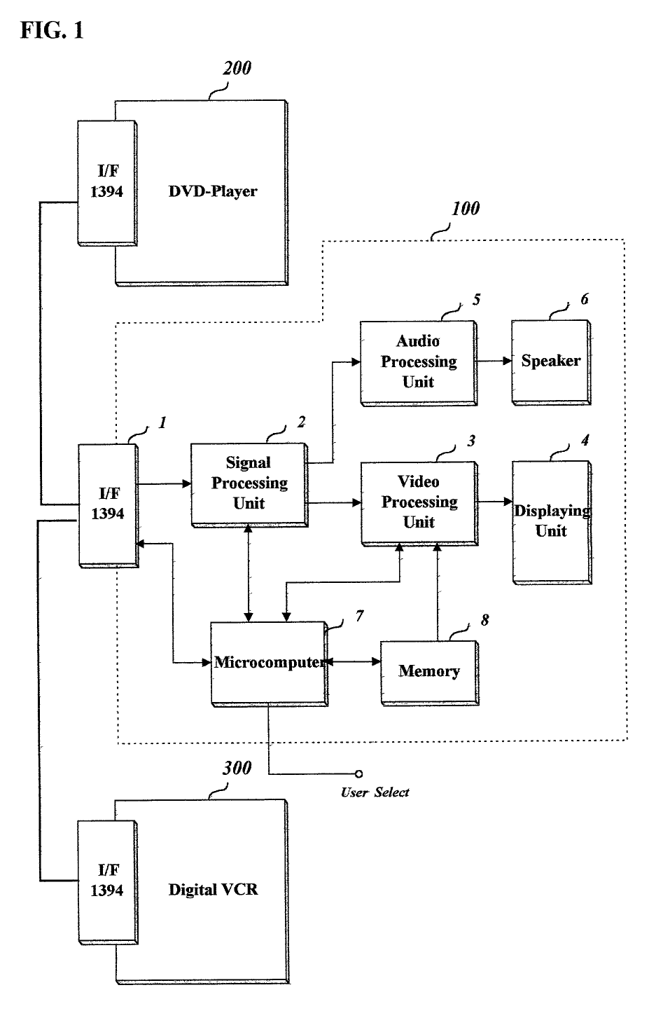

FIG. 1 shows a partial block diagram of a digital television embodying the present invention. The digital television 100 comprises an IEEE 1394 interface 1 through which it is connected to external devices such as a DVD player 200 and digital video cassette recorder (hereinafter, D-VCR) 300; a signal processing unit 2 for decoding audio/video data from data stream that are received from the DVD player 200; an audio processing unit 5 for producing analog audio signal from the audio data stream decoded by the signal processing unit 2; a speaker 6 for generating sounds from the analog audio signal; a video processing unit 3 for producing display video signal from the video data stream; a displaying unit 4 for displaying the video signal produced by the video processing unit 3; a microcomputer 7 for controlling the operations of the constituting components above; and a memory 8 for storing data required for the control operations of the microcomputer 7 and storing temporary data.

First, the microcomputer 7 examines through the interface 1 what external devices are connected to the digital television 100. Based on connected devices, a menu image is constructed and then displayed on the displaying unit 4 under control of the microcomputer 7, each menu item corresponding to each of the connected external devices.

When a particular external device, for example, the DVD player 200 is selected from the menu, another menu including menu items for the operations or functions of the DVD player 200 is requested to the DVD player 200 and is then displayed on the displaying unit 4 such that the an operation or function, e.g., play operation is selected from the menu. The menu-based request of the play operation of a DVD loaded in the DVD player 200 is described below in detail.

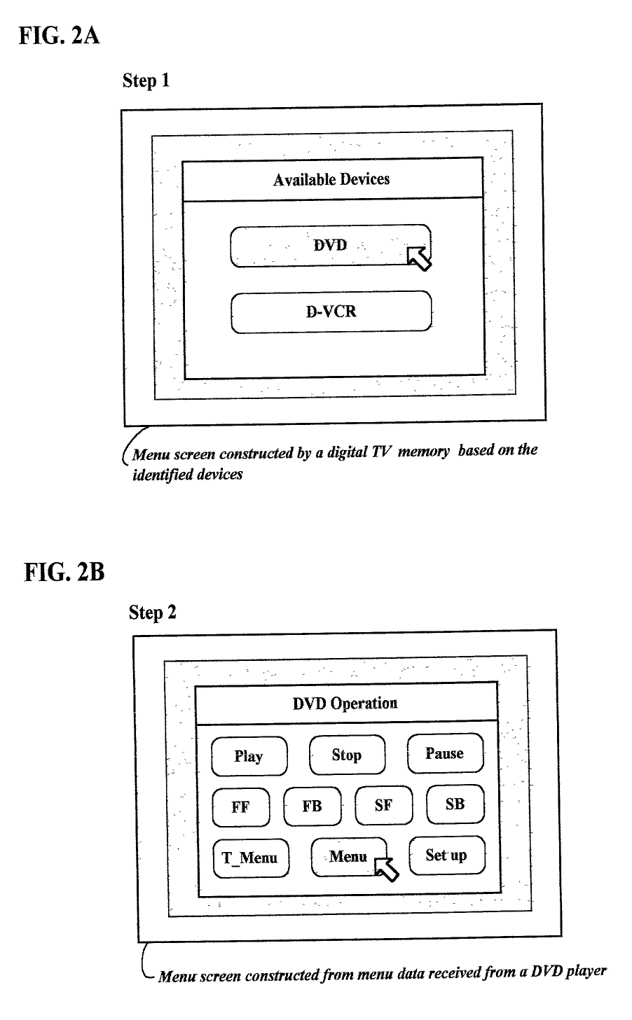

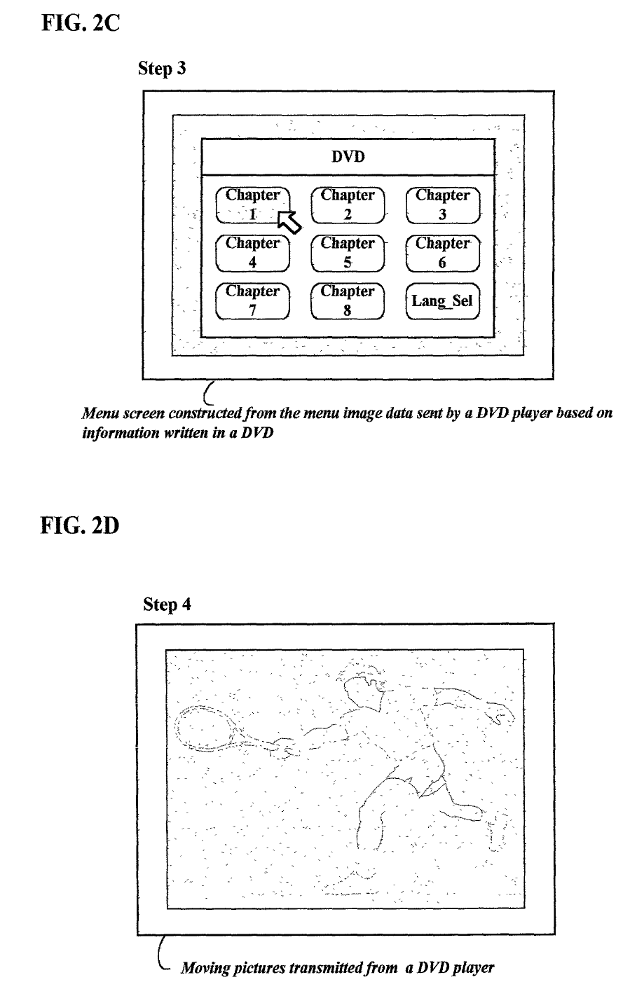

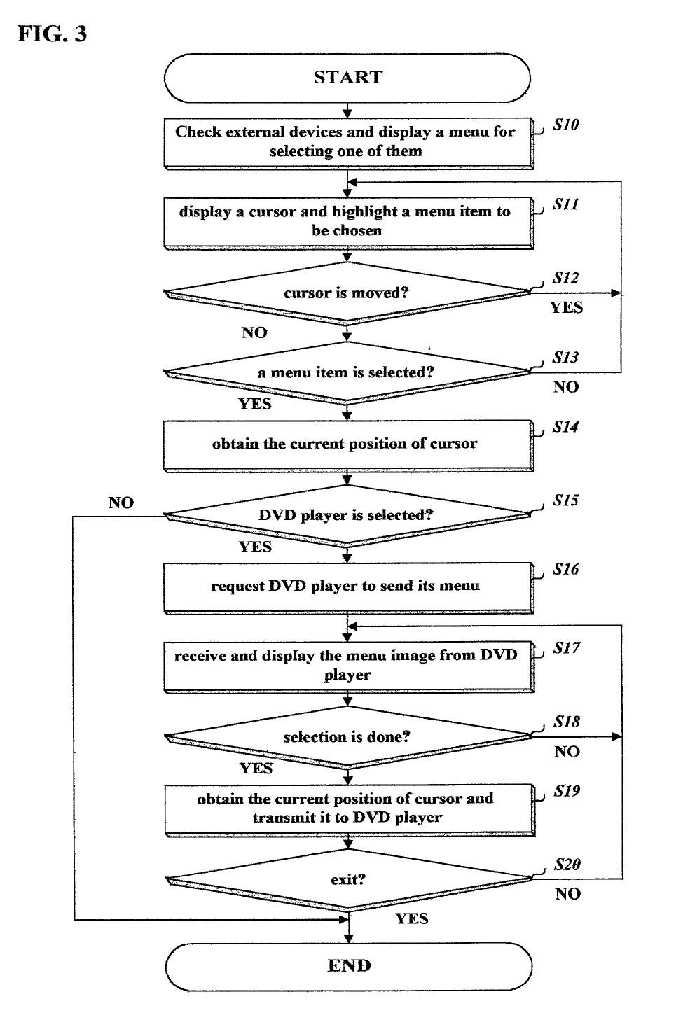

FIG. 2A depicts a menu image including menu items for selecting external devices that are connected to the digital television 100 through the 1394 IEEE interface. FIG. 2B shows another menu image including menu items for selecting and requesting operations or functions of the DVD player 200. FIG. 2C shows a chapter menu image including menu items for selecting chapters of a particular title in the DVD, the chapter menu being requested from the menu of FIG. 2B. In response to the selection of a chapter from the chapter menu, the DVD player 200 reproduces the corresponding audio/video signals from the DVD and then transmits them to the digital television 100, as shown in FIG. 2D. The detailed procedure of generating and displaying the menu images is described below.

On receiving an input key signifying the request of the menu from which a user chooses one of connected external devices, the microcomputer 7 starts to communicate with the external devices to know what external devices are connected. Instead, what devices are connected can be determined at the time of the power-on of the digital television 100 or at the first time that they are connected through the IEEE 1394 interface.

Suppose that it is determined that a DVD player 200 and a DVHS 300 are connected to the digital television 100. The menu image shown in FIG. 2A including two menu items for the DVD player 100 and the DVHS 300 is generated and fed to the video processing unit 3 under control of the microcomputer 7 such that the menu is displayed on the displaying unit 4 (S10). At this time, in order to help a user select a menu item from the menu, the microcomputer 7 re-generates data required to display the menu image such that the cursor pointed by a remote pointing device is displayed on the menu image and that the menu item over which the cursor is positioned is highlighted (S11).

The microcomputer 7 keeps tracking the position of the cursor on the menu image. When the cursor has been moved to another menu item by a remote pointing device, the menu item is determined and highlighted (S12). When a selection key is inputted while the cursor has been positioned over that menu item (S13), the microcomputer 7 determines which menu item is selected by examining the current position of the cursor (S14). For example, if the menu item for selecting the DVD player 200 is selected (S15), a command signifying the request of the menu image provided by the DVD player 200 is transmitted to the DVD player 200 through the interface 1 (S16).

In response to the command, the DVD player 200 reads menu data required to display the menu image shown in FIG. 2B from data stored in its memory and then sends the menu data to the digital television 100. The menu data consist of a menu image that can be directly decoded without additional image construction process and displayed by the video processing unit 3 as well as the position data of the menu items on the menu image. Then, the menu image is received and displayed on the displaying unit 3, as shown in FIG. 2B (S17).

As in the menu image shown in FIG. 2A, the cursor that is movable by the remote pointing device is displayed on this menu image and the menu item over which the cursor is positioned is highlighted based on the position data of the menu items. When a selection key, i.e., ENTER key is inputted while the cursor has been positioned over a particular menu item (S18), the microcomputer 7 obtains the current position of the cursor and then transmits it to the DVD player 200 (S19).

However, in the case where the position data of the menu items are not included in the menu data received from the DVD player 200, the highlight function of the menu item over which the cursor is positioned is not activated. At the instant that a user enters a selection key, the current position of the cursor is obtained and is then transmitted to the DVD player 200.

Once the current position of the cursor is received, the DVD player 200 determines which menu item has been selected by using the position of the cursor and respective areas designated for menu items on the menu image shown in FIG. 2B. For example, if a user selects the MENU item from the menu to request a list of chapters belonging to a particular title on the DVD, the DVD player 200 transmits to the digital television 100 the chapter selection menu in the image format, which has been read out when the DVD is loaded initially on the DVD player 200. Receiving the chapter menu, the digital television 100 displays the chapter menu, as shown in FIG. 2C.

After that, when a user chooses one of the chapters by inputting a selection key while positioning the cursor over the corresponding chapter item, the current position of the cursor is obtained by the microcomputer 7 and is then sent to the DVD player 200. Based on the position of the cursor and respective areas designated for menu items on the image of the chapter selection menu, the DVD player 200 determines which chapter has been selected by the user. For example, if it is determined that the menu item for chapter #1 is chosen, the DVD player 200 locates the start address of the first chapter of the desired title on the DVD and then starts to play the chapter. The data stream of the chapter reproduced are, in turn, transmitted to the digital television 100.

After the data stream are received through the interface 1, the data stream are divided into the video and audio stream through the signal processing unit 2. The audio stream are decoded by the audio processing unit 5 and are then sent to the speaker 6. At the same time, the video stream are decoded by the video processing unit 3 and are then sent to the display 4. Through the procedure above, the user can view a particular chapter being reproduced by the DVD player 200 on the digital television 100, as shown in FIG. 2D.

In the case where the DVD player 200 is connected to a digital audio apparatus without an image display, it is possible that information about the menus provided by the DVD and the DVD player 200 are transmitted to the digital audio apparatus in the text form and that the text menu items are displayed on a small liquid crystal display (LCD) on the digital audio apparatus. In this case, the digital audio apparatus is equipped with a keypad consisting of arrow keys or numeric keys to enable a user to select a menu item by using arrow keys or numeric keys. Once a menu item is selected, the digital audio apparatus transmits a command associated with the menu item to the DVD player 200 in order to request the corresponding operation.

Accordingly, the present invention enables a user of a digital apparatus like a digital television to conveniently request and execute various operations or functions of external digital devices that are connected to the digital apparatus without the direct control of or access to the external digital devices.

The foregoing is provided only for the purpose of illustration and explanation of the preferred embodiments of the present invention, so changes, variations and modifications may be made without departing from the spirit and scope of the invention.

What is claimed is:

1. A method of menu-based remote control of external devices that are connected to an audio/video apparatus, comprising the steps of:
(a) displaying a menu image including menu items, each menu item corresponding to each external device, such that one of the external devices is selected from the menu;
(b) requesting to the external device that is selected from said menu a menu data including detailed menu items associated with operations of said selected external device; and
(c) receiving the menu data for the detailed menu from said selected external device and displaying the menu image, the menu data being provided from the selected device without data conversion for constructing . menu screen.

2. A method according to claim 1, wherein each menu item of said menu image in said step (a) corresponds to each of the external devices that are connected to said audio/video apparatus through IEEE 1394 interface.

3. A method according to claim 1, further comprising the step of checking what external devices are connected through a common bus before said step (a)

4. A method according to claim 3, wherein said checking step is performed in response to a user request of said menu for selection of said external devices.

5. A method according to claim 3, wherein said checking step is performed when communication with said external devices through the common bus is possible.

6. A method according to claim 1, further comprising the step of displaying a menu item differently from other menu items on the menu image displayed in said step (c) when a cursor is positioned over the menu item during the movement of the cursor.

7. A method according to claim 6, wherein said menu item over which said cursor is positioned is displayed differently from other menu items on the basis of information about the positions of menu items on said menu image, said information being provided by said selected external device.

8. A method according to claim 1, further comprising the step of transmitting information about the current position of a cursor on the menu image displayed in said step (c) to said selected external device when a selection key is entered by a user.

9. A method of menu-based remote control of external devices that are connected to an audio/video apparatus, comprising the steps of:
(a) displaying a menu image including menu items, each menu item corresponding to each external device, such that one of the external devices is selected from the menu;
(b) requesting to the external device that is selected from said menu a menu data including detailed menu items associated with operations of said selected external device
(c) receiving the menu data for the detailed menu from said selected external device and displaying the menu image, the menu data being provided from the selected device without data conversion for constructing . menu screen; and
(d) obtaining information about the position of a cursor on said image of the detailed menu in response to a user input and transmitting said information to said external device.

10. A method according to claim 9, wherein a menu item over which said cursor is positioned during the movement of said cursor is displayed differently from other menu items in color and/or brightness.
